(19) United States
(12) Patent Application Publication
(10) Pub. No.: US 2007/0108396 A1
(43) Pub. Date: May 17, 2007

(54) Device for generating and emitting XUV radiation

(76) Inventor: Alfred Reinhold, Garbsen (DE)

Correspondence Address: SHLESINGER, ARKWRIGHT & GARVEY LLP, 1420 KING STREET, SUITE 600, ALEXANDRIA, VA, 22314, US

(21) Appl. No.: 11/604,386

(22) Filed: Nov. 27, 2006

Related U.S. Application Data
(63) Continuation of application No. PCT/EP05/04843, filed on May 4, 2005.

(30) Foreign Application Priority Data
May 27, 2004 (DE) 10 2004 025 997.6

(51) Int. Cl. G21G 4/00

(52) U.S. Cl. 250/493.1

(57) ABSTRACT

Device for generating and emitting XUV radiation includes a target which emits XUV radiation when impacted by electrically charged particles, in use. The target has a base, and the base is at least partially provided with a first layer. The first layer includes a material which emits XUV radiation when impacted by electrically charged particles, in use. Further, at least a second layer is provided, the at least a second layer including a material having a high electrical conductivity. A target which emits XUV radiation when impacted by electrically charged particles is provided for use with a device for generating and emitting XUV radiation.

### CROSS-REFERENCE TO RELATED APPLICATIONS

This application is a continuation of application no. PCT/EP2005/004843, filed May 4, 2005, which claims priority of German application no. 10 2004 025 997.6, filed May 27, 2004, and which is incorporated herein by reference.

### FIELD OF THE INVENTION

The invention relates to a device for generating and emitting XUV radiation, with a target that emits XUV radiation when impacted by electrically charged particles.

### BACKGROUND OF THE INVENTION

XUV (extreme ultraviolet; also known as EUV) radiation is understood as radiation that is within a wavelength range of between approximately 0.25 and 20 nm.

This type of XUV radiation is used, for example, in optical lithography processes employed in the mass production of semiconductor chips.

From WO 2004/023512 A1 a device and a method for generating XUV radiation are known. The device known from the publication has a target that is made of a material that emits XUV radiation when impacted by electrically charged particles. The publication proposes that the target be formed especially from silicon or beryllium.

The use of beryllium is disadvantageous, because the XUV radiation emitted by beryllium is not monochromatic.

When silicon is used as the target material, the emitted XUV radiation is at least approximately monochromatic. However one significant disadvantage in the use of silicon or other semiconductors as the target material consists in the fact that the target becomes electrically charged under certain conditions. Under such conditions, uncontrolled discharges form, which impede a controlled generation of XUV radiation or make such generation impossible.

A similar device for generating XUV radiation is also known from U.S. Pat. No. 3,138,729.

From EP 0 887 639 A1 the use of beryllium as the target material is known.

From U.S. Pat. No. 3,793,549 and GB 1057284, devices for generating x-ray radiation are known.

From U.S. Pat. No. 4,523,327 a device of the relevant type for generating and emitting XUV radiation is known, which has a target that emits XUV radiation when impacted by electrically charged particles. The target has a base that is at least partially provided with a first layer, which contains a material that emits XUV radiation when impacted by electrically charged particles. With the device known from the publication, the base can be made, for example, of copper, which is coated, for example partially, with silicon for its formation.

### OBJECTS AND SUMMARY OF THE INVENTION

An object of the invention is to overcome the drawbacks of the prior art devices for generating and emitting XUV radiation.

An object of the invention is to provide a device for generating and emitting XUV radiation that is improved relative to the prior art.

This object is attained with the teachings set forth herein and in the claims.

According to the invention, in addition to the first layer, which contains a material, such as silicon, that emits XUV radiation when impacted by electrically charged particles, a second layer is provided, which contains a material of high electrical conductivity. The purpose of this second layer is to divert electrically charged particles that impact the target, and thus prevent a residual charge of the target. Because the material of high electrical conductivity is applied to the base in the form of a layer, in principle it is no longer necessary to form the base itself from a material of high electrical conductivity. Thus, the material of the base can be selected from within a wide range of possibilities, based upon relevant requirements, wherein predominantly the mechanical properties of the material are considered, for example in order to ensure sufficient cooling and mechanical stability of the target. Thus it is especially possible to produce the base for the target from a material that is more cost-effective than the material of the second layer.

The shape, size and material of the base can be selected from a wide range of possibilities. The base can especially be made of metal, in order to ensure both sufficient cooling and a high mechanical stability of the target.

One advantageous further development of the teaching of the invention provides that the second layer is arranged between the base and the first layer. In this embodiment, the layer that emits XUV radiation can especially be arranged on the surface of the target, while the second layer is arranged between the base and the first layer, so that the electrically charged particles impact directly on the layer that emits XUV radiation.

According to relevant requirements, however, the first layer can also be arranged between the base and the second layer. In this embodiment the second layer can especially form the surface of the base, with the thickness of the second layer being selected such that an impacting of the electrically charged particles on the layer that emits XUV radiation is ensured.

According to the invention, the first layer can contain a single material that emits XUV radiation when impacted by electrically charged particles. According to the invention, the first layer can also contain or be comprised of multiple different materials that emit XUV radiation when impacted by electrically charged particles. According to the invention, the first layer can contain, for example, niobium, carbon, nitrogen, scandium or oxygen. One particularly preferred further development of the teaching of the invention provides that the first layer contains beryllium and/or molybdenum and/or silicon and/or at least one silicon compound, especially a silicon nitride and/or a silicon carbide and/or metal-dosed silicon, or is comprised of at least one of the aforementioned materials.

Another advantageous further development provides that the second layer contains at least one metal, especially copper, or is comprised of at least one metal, especially copper. Metals are available as cost-effective materials having high electrical conductivity.

In principle it is sufficient for the target of the device according to the invention to comprise a base and at least two layers, namely the first layer and the second layer. However it is also possible for the base to be provided with more than two layers. In addition to the first layer and the layers provided on the second layer, a material can be provided which can especially be comprised of a material that emits XUV radiation when impacted by electrically charged particles, or which can be comprised of a material of high electrical conductivity. One advantageous further development of the teaching of the invention provides that at least a third layer is provided, for the purpose of influencing the spectral composition of the XUV radiation emitted by the target. In this embodiment, the third layer forms a filter layer for the spectral filtering of the emitted XUV radiation.

Other advantageous further developments of the teaching of the invention provide that the first layer has a layer thickness of approximately 0.5-2 μm and/or that the second layer has a layer thickness of approximately 500-1,000 μm.

A layer thickness of the first layer of 0.5-2 μm is particularly preferred. Surprisingly, with this type of layer thickness an optimal compromise is achieved between the yield of XUV radiation and an electrical discharge of the electrons.

In principle, it is possible for the second layer not only to divert electrons in the necessary manner, but also to serve to dissipate heat. A further development of the teaching of the invention provides that, especially between the second layer and the base, at least a fourth layer is provided, which contains a material having high thermal conductivity. In this embodiment, the dissipation of heat is accomplished via the fourth layer, so that the function of the second layer consists essentially in diverting electrons.

In the aforementioned embodiment, the fourth layer can preferably be comprised of diamond or a similar substance, and/or can have a layer thickness of approximately 500-1,000 μm.

Because in the aforementioned embodiments the second layer can essentially serve to divert electrons, the second layer in these embodiments can be structured to be very thin. Preferably, the second layer has a layer thickness of approximately 5-10 μm.

The target according to the invention can include that the second layer is arranged between the base and the first layer.

The target according to the invention can include that the first layer is arranged between the base and the second layer.

The target according to the invention can include that the first layer contains beryllium and/or molybdenum and/or silicon and/or at least one silicon compound, especially at least one silicon nitride and/or one silicon carbide and/or metal-dosed silicon, or is comprised of at least one of the aforementioned materials.

The target according to the invention can include that the second layer contains at least one metal, especially copper, or is comprised of at least one metal, especially copper.

The target according to the invention can include that at least a third layer for influencing the spectral composition of the XUV radiation emitted by the target is provided.

The target according to the invention can include that the first layer has a layer thickness of approximately 0.5-2 μm.

The target according to the invention can include that the second layer has a layer thickness of approximately 500-1,000 μm.

The target according to the invention can include that especially between the second layer and the base at least a fourth layer is provided, which contains a material having a high thermal conductivity.

The target according to the invention can include that the fourth layer is comprised of diamond or some similar material.

Below, the invention will be described in greater detail with reference to the attached, highly schematic set of drawings, in which an exemplary embodiment of a device according to the invention and a target according to the invention are represented. In this, all characterizing features described or represented in the drawings, alone or in any combination, represent the object of the invention, regardless of their composition in the claims, and regardless of their formulation or representation in the description or in the drawings.

Relative terms such as up and down are for convenience only and are not intended to be limiting.

### BRIEF DESCRIPTION OF THE DRAWINGS

FIG. 1 is a highly schematic representation of a side view of a device according to the invention, with a target according to the invention,

FIG. 2 is for the purpose of clarifying the sequence of layers, a highly schematic cross-section through a first exemplary embodiment of a target according to the invention,

FIG. 3 is, in the same representation as in FIG. 2, a second exemplary embodiment of a target according to the invention, and

FIG. 4 is, in the same representation as in FIG. 2, a third exemplary embodiment of a target according to the invention.

### DETAILED DESCRIPTION OF THE INVENTION

In the figures in the set of drawings, equivalent or corresponding components are provided with the same reference symbols.

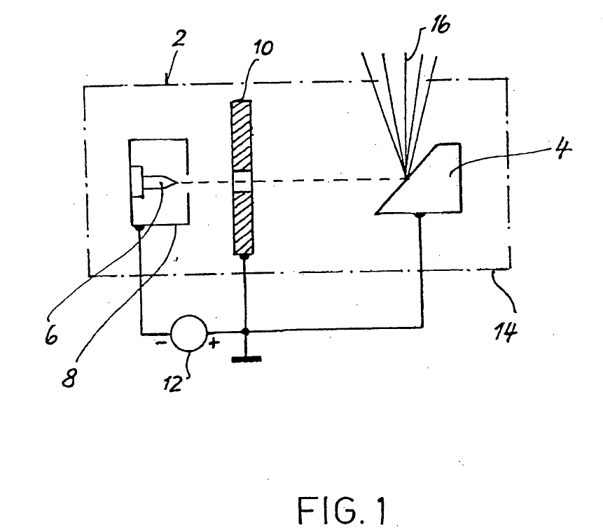

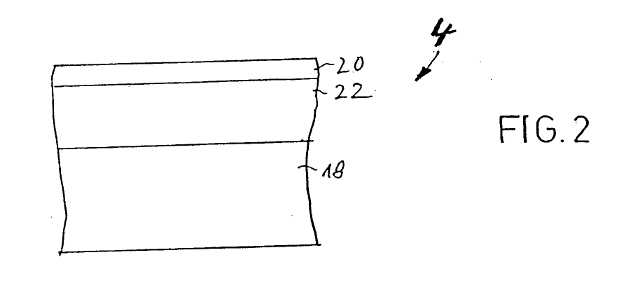

In FIG. 1, an exemplary embodiment of a device 2 according to the invention for generating and emitting XUV radiation is illustrated, which has a target 4 according to the invention, which will be described in greater detail further below in reference to FIG. 2. The device 2 has a heating filament 6, through which a heating current flows during operation of the device 2 of the invention, and from which electrons depart during operation of the device 2, in the manner known to one of ordinary skill in the art. To bundle the electrons emitted from the heating filament 6 into an electron flow, the heating filament 6 is encompassed by a Wehnelt cylinder 8. The electron flow emitted from the heating filament 6 is accelerated through an annular anode 10 in the direction of the target 4. To accelerate the electrons, a high-voltage source 12 is provided, which is connected with its negative high-voltage terminal with the cathode unit formed by the heating filament 6 and the Wehnelt cylinder 8. In place of the heating filament, the cathode unit can also have a field-emission cathode or a Schottky cathode. The positive terminal of the high-voltage source 12 is connected to the anode 10 and the target 4, and is grounded. Thus the acceleration of the electrons emitted by the heating filament occurs between the cathode unit and the anode 10. After passing through the annular anode 10, the electrons move toward the target 4, where they are decelerated. In the direction of movement of the electrons between the anode 10 and the target 4, a device for shaping the electron flow, not illustrated in the drawing, can optionally be provided especially for its focusing and/or centering.

In this exemplary embodiment, the components of the device 2 are arranged in a vacuum tube 14, as is generally known for x-ray tubes by one of ordinary skill in the art.

The target 4 emits XUV radiation when it is impacted by the electron flow, as indicated in FIG. 1 by the reference symbol 16, which then exits the vacuum tube 14.

In FIG. 2 a section through a first exemplary embodiment of a target 4 according to the invention is represented, which has a base 18 that is provided with a first layer 20, which in this exemplary embodiment forms the surface of the target 4 that faces the electron flow and emits XUV radiation when it is impacted by the electrons. In this exemplary embodiment the first layer 20 is comprised of silicon. According to the invention, in addition to the first layer 20 a second layer 22 is provided, which is made of a material having a high electrical conductivity, and in this exemplary embodiment is arranged between the base 18 and the first layer 20. In this exemplary embodiment, the second layer 22 is made of copper, while the base 18 is made of aluminum, wherein the first layer 20 has a layer thickness of approximately 0.5-2 μm and the second layer has a layer thickness of approximately 1,000 μm.

According to the invention, the first layer 20 serves to generate the XUV radiation, while the second layer 22, due to its high electrical conductivity, prevents the surface of the target 4 from becoming electrically charged due to the semiconductive properties of the first layer 20, which would impair or prevent a controlled generation of XUV radiation. Furthermore, the second layer in this exemplary embodiment serves to dissipate heat. In contrast, the base 18 serves primarily as a mechanical support for the layers 20, 22.

The method of functioning of the device 2 of the invention is as follows:

During operation, the electrons emitted from the heating filament 6 and bundled by the Wehnelt cylinder 8 to an electron flow are accelerated via the electrical field generated by the high-voltage source 12 in the direction of the target 4. When the first layer 20 of the target 4 is impacted, the target emits XUV radiation 16 in the desired manner. With the second layer 22, which is in contact with the first layer 20, and which according to the invention has a high electrical conductivity, the electrons are diverted from the first layer 20, so that a permanent electrical charging of the first layer 20 is reliably prevented.

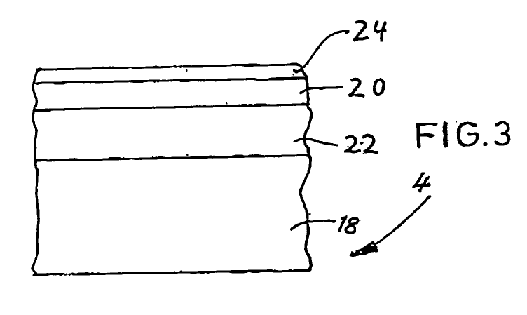

In FIG. 3 a second exemplary embodiment of the target 4 according to the invention is represented, which differs from the exemplary embodiment according to FIG. 2 in that a third layer 24 is arranged on the surface of the second layer 22. The third layer 24 forms a filter layer for the spectral filtering of the emitted XUV radiation in order to influence the spectral composition of the XUV radiation emitted by the target 4.

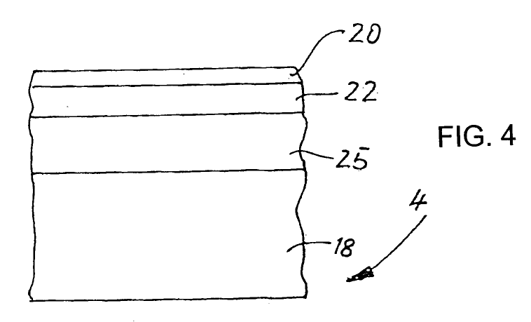

In FIG. 4 a third exemplary embodiment of a target 4 according to the invention is represented, which differs from the exemplary embodiment according to FIG. 2 in that a fourth layer 25 is arranged between the second layer 22 and the base 18, which in this exemplary embodiment is made of a material having a high thermal conductivity, namely of diamond, and has a layer thickness of 500-1,000 μm. Because the heat dissipation is accomplished via the fourth layer 25, the dimensioning of the second layer 25 can be based exclusively upon its function of diverting electrons. For this purpose, it is sufficient for the second layer 22 to have a layer thickness of 5-10 μm.

While this invention has been described as having a preferred design, it is understood that it is capable of further modifications, and uses and/or adaptations of the invention and following in general the principle of the invention and including such departures from the present disclosure as come within the known or customary practice in the art to which the invention pertains, and as may be applied to the central features hereinbefore set forth, and fall within the scope of the invention or limits of the claims appended hereto.

1. Device for generating and emitting XUV radiation, comprising:
a) a target which emits XUV radiation when impacted by electrically charged particles, in use;
b) the target having a base, the base being at least partially provided with a first layer;
c) the first layer including a material which emits XUV radiation when impacted by electrically charged particles, in use; and
d) at least a second layer being provided, the at least a second layer including a material having a high electrical conductivity.

2. Device according to claim 1, wherein:
a) the at least a second layer is arranged between the base and the first layer.

3. Device according to claim 1, wherein:
a) the first layer is arranged between the base and the at least a second layer.

4. Device according to claim 1, wherein:
a) the first layer contains or is at least one of beryllium, molybdenum, silicon, and at least one silicon compound.

5. Device according to claim 1, wherein:
a) the second layer contains or is at least one metal.

6. Device according to claim 1, wherein:
a) at least a third layer configured for the purpose of influencing the spectral composition of the XUV radiation emitted by the target is provided.

7. Device according to claim 1, wherein:
a) the first layer has a layer thickness of approximately 0.5-2 μm.

8. Device according to claim 1, wherein:
a) the second layer has a layer thickness of approximately 500-1,000 μm.

9. Device according to claim 1, wherein:
a) between the second layer and the base at least a fourth layer is provided, which contains a material having a high thermal conductivity.

10. Device according to claim 9, wherein:
a) the fourth layer is comprised of diamond.

11. Device according to claim 9, wherein:
a) the fourth layer has a layer thickness of approximately 500-1,000 μm.

12. Device according to claim 9, wherein:
a) the second layer has a layer thickness of approximately 5-10 μm.

13. Target for a device for generating and emitting XUV radiation, the target emitting XUV radiation when impacted by electrically charged particles, in use, the target comprising:
a) a base, the base being at least partially provided with a first layer;
b) the first layer including a material which emits XUV radiation when impacted by electrically charged particles, in use; and
c) at least a second layer being provided, the at least a second layer including a material having a high electrical conductivity.

14. Target according to claim 13, wherein:
a) the at least a second layer is arranged between the base and the first layer.

15. Target according to claim 13, wherein:
a) the first layer is arranged between the base and the at least a second layer.

16. Target according to claim 13, wherein:
a) the first layer contains or is at least one of beryllium, molybdenum, silicon, and at least one silicon compound.

17. Target according to claim 13, wherein:
a) the second layer contains or is at least one metal.

18. Target according to claim 13, wherein:
a) at least a third layer configured for the purpose of influencing the spectral composition of the XUV radiation emitted by the target is provided.

19. Target according to claim 13, wherein:
a) the first layer has a layer thickness of approximately 0.5-2 μm.

20. Target according to claim 13, wherein:
a) the second layer has a layer thickness of approximately 500-1,000 μm.

21. Target according to claim 13, wherein:
a) between the second layer and the base at least a fourth layer is provided, which contains a material having a high thermal conductivity.

22. Target according to claim 21, wherein:
a) the fourth layer is comprised of diamond or some similar material.

23. Target according to claim 21, wherein:
a) the fourth layer has a layer thickness of approximately 500-1,000 μm.

24. Target according to claim 21, wherein:
a) the second layer has a layer thickness of approximately 5-10 μm.

25. Target according to claim 13, wherein:
a) the first layer contains or is at least one of silicon nitride, silicon carbide, and metal-dosed silicon.

26. Target according to claim 13, wherein:
a) the second layer contains or is copper.

27. Device according to claim 1, wherein:
a) the first layer contains or is at least one of silicon nitride, silicon carbide, and metal-dosed silicon.

28. Device according to claim 1, wherein:
a) the second layer contains or is copper.
